(19) United States
(12) Patent Application Publication
(10) Pub. No.: US 2026/0315957 A1
(43) Pub. Date: Oct. 15, 2026

(54) CENTRIFUGAL PARTITION CHROMATOGRAPHY EXTRACTION CELL, ROTOR PROVIDED WITH THIS, ITS USE IN CENTRIFUGAL PARTITION CHROMATOGRAPHY APPARATUS, AND CHROMATOGRAPHIC METHOD

(71) Applicant: LILICHRO KFT., Gödöllö (HU)

(72) Inventors: László NÉMETH, Dabas (HU); Ferenc FÁBIÁN, Kakucs (HU); Attila DECSI, Kerepes (HU)

(73) Assignee: LILICHRO KFT., Gödöllö (HU)

(21) Appl. No.: 19/483,760

(22) PCT Filed: May 2, 2024
(86) PCT No.: PCT/HU2024/050032

§ 371 Date: Nov. 12, 2025

(30) Foreign Application Priority Data
May 12, 2023 (HU) P2300161

(51) Int. Cl. B01D 15/18; G01N 30/38; G01N 30/42

(52) U.S. Cl. CPC B01D 15/1894; G01N 30/42; G01N 2030/381

(57) ABSTRACT

The object of the invention relates to a helical piece insert for use in a centri fugal partition chromatography extraction cell and a centri fugal partition chromatography extraction cell comprising such insert, as well as to a method for its production, where the axial direction of the helical piece is substantially parallel to the longitudinal axis of the cell and the helical piece lies up against the wall of the centri fugal partition chromatography extraction cell at its part closer to the extraction cell wall or the helical piece is formed in such a way so that when the rotor containing the centri fugal partition chromatography extraction cell is rotating at the speed required for the given separation the helical piece rests up against the cell wall at its part closer to the extraction cell wall. The object of the invention also relates to a rotor for centri fugal partition chromatography apparatus which contains the centri fugal partition chromatography extraction cells according to the present invention as well as a centri fugal partition chromatography apparatus that contains such rotor and the use of the rotor for centrifugal partition chromatography separation.

### CROSS REFERENCE TO RELATED APPLICATIONS

This application is a 35 U.S.C. § 371 National Stage of International Patent Application No. PCT/HU2024/050032, filed May 2, 2024, claiming benefit from Hungarian Patent Application No. P2300161, filed May 12, 2023, the disclosures of which are incorporated herein in their entirety by reference, and priority is claimed to each of the foregoing.

### FIELD OF THE INVENTION

The object of the invention relates to a centrifugal partition chromatography extraction cell, particularly to its insert. The object of the invention also relates to a centrifugal partition chromatography rotor containing such an extraction cell, a centrifugal partition chromatography apparatus containing such a rotor, to the use of the cell and the rotor in a centrifugal partition chromatography apparatus, and to a chromatography method implemented with the centrifugal partition chromatography extraction cell.

### BACKGROUND

In the chemicals industry and in other branches of industry dealing with or using chemical materials it is frequently necessary to separate mixtures of materials into their constituent parts, which methods are collectively known as separation techniques.

Among separation techniques there is differentiation made between industrial methods and analytical methods. It should be noted that this is not a strict differentiation, analytical methods may be partially or completely used in industrial methods and vice versa. Analytical methods include physical-chemical methods, and these include chromatography methods. Chromatography is a separation method based on the difference of material transfer between a stationary phase and a mobile phase in contact with it. The components of the material mixture to be separated, i.e. components of the sample are able to create interactions with the stationary phase and the mobile phase of varying type and degree, in other words the components remain in the stationary phase for a different amount of time compared to the mobile phase, i.e. their retention differs. In chromatography the stationary phase may be a solid or a liquid, and with respect to its physical state the mobile phase may be a gas, a supercritical fluid, or a liquid.

In the case of liquid-liquid chromatography (abbreviated as: LLC) methods, both the stationary phase and the mobile phase are liquids, which liquids are not substantially miscible. The distribution of the components of the sample also differs between the two liquids; the transfer of material takes place at the interface between the two liquids. Those liquid-liquid chromatography methods in which the stationary phase is created from liquid phase solvent or a multi-component solvent mixture as a result of the centrifugal force (in other words the apparatus contains a rotor that contains cells that provide a space for the stationary and mobile phases to come into contact), and in which the mobile phase is also a liquid are called centrifugal partition chromatography (abbreviated as CPC).

The most rudimentary predecessor of partition chromatography is the device known as the Craig Apparatus created by Lyman C. Craig in 1943 and based on Counter-Current Distribution (abbreviated as CCD). The Craig Apparatus is a series of glass tubes arranged so that the lighter liquid phase moves from one tube to the other. The liquid-liquid extractions are performed simultaneously in all the tubes of the usually electromechanically driven apparatus [Craig, L. C.; Post, O., Anal. Chem., 1949, 21 (4), 500-504.].

This was followed in the 1970s by Droplet Counter-Current Chromatography (abbreviated as DCCC or DCC). DCCC is a liquid-liquid separation method in which the liquid stationary phase is kept in a collection of vertical glass columns connected in series, and the mobile phase passes through the columns in the form of droplets [Tanimura, T.; Pisano, J. J.; Ito, Y.; Bowman, R. L., 1970, Droplet Countercurrent Chromatography, Science, 169 (3940), 54-56.]. In these rudimentary liquid-liquid separation methods, the stationary phase was immobilised by gravitational force. It was only in the 1980s that centrifugal force was used to create the immobilised stationary phase in an apparatus adapted for liquid-liquid separation. Compared to counter-current chromatography methods, centrifugal partition chromatography is faster as a result of the greater flow speed, thereby it makes it possible to have a separation method with greater productivity, which method can then be used in industry. In addition, a significant advantage of centrifugal partition chromatography as opposed to DCCC and CCC (Counter-Current Chromatography) is that it can also be created and used at the industrial scale.

Several chromatography apparatuses are known of in the state of the art that use centrifugal force.

Patent application with publication number WO21259577A1 discloses a universal rotor that may be used for all systems that are adapted for the centrifugal acceleration of liquids.

This type of rotors may be used in chromatographic purification, extraction, separation, centrifugal partition chromatography and in liquid-liquid extraction. The rotor according to the invention is set up from one or more discs placed on each other, the rotors contain a series of cells, which are positioned on the rotor radially (i.e. the longitudinal axis of the individual cells is positioned radially) or at an angle (i.e. the longitudinal axis of the individual cells is at an angle to the radius).

Patent application No. EP3204136A1 presents an extraction cell that may be used for centrifugal partition chromatography, and its production. The extraction cell is tube-like, which has an inlet and outlet plug connected to its inlet and outlet ends. An insert that liquids may pass through may be placed into the extraction cell, which insert reduces the undesirable turbulent flow caused by Coriolis force and increases the material-transfer surface between the two phases (stationary and mobile). The insert may have a regular or irregular structure, or may be a bulk insert. The volume of the material constituting the insert is small compared to the volume of the cell, as the mobile phase has to pass through the stationary phase in the space containing the insert. The insert may have a mesh structure, for example. However, due to this the geometry of such insert is not stable against various forces. As a consequence, while the cell is in operation, this mesh insert located in the cell becomes compressed due to the effect of the centrifugal force, and as a consequence the cell's separation efficiency deteriorates. Patent application no WO2017037489A1 is very similar to this in terms of its topic.

The object of patent application No. US2013005556AA relates to an apparatus and method during which immiscible liquid phases come into contact with each other as a result of centrifugal force. The apparatus contains at least one unit adapted for bringing the liquids into contact with each other, which, according to the specification, may rotate around the axis X′X, and which contains several cells. The liquid phases pass through the cells after each other, which cells are provided with two input and two output channels.

Patent application No. WO2013036803A1 discloses precoated rotors that may be used for preparative centrifugal thin-layer chromatography. The coating of the rotors may be, for example, reversed phase silicon dioxide, including reversed phase silica gel that is provided with modified functional groups and/or chiral groups. In addition, the invention relates to a chromatography-based separation system that contains binder-free sorbents between two discs.

Patent application No. US2008035546A1 relates to an optimal dimensioning method of the cells of a centrifugal partition chromatograph. When increasing scale (from the analytical scale towards industrial scales) it is recommended to increase the third dimension of the three-dimensional cells, which third dimension is the dimension parallel to the axis of rotation.

The rotor of the centrifugal partition chromatograph disclosed in patent application No. US2004173534AA contains at least one thick-walled cylindrical body, which cylindrical body contains multiple cells (even as many as several hundred long cells may be located in it), which are connected in series to each other via channels. The rotating apparatus can withstand pressure in excess of 100 bar, in other words it may be used to good effect in industry too. In one of the embodiments the cells themselves are arranged around the axis of rotation in a spiral helix.

Patent No. EP1166100B1 relates to a centrifugal partition chromatography device that contains at least one rotor disc that may rotate around an axis, which contains a multitude of cells connected in series via channels. The more the mobile phase entering the cell becomes atomised, the more efficient such devices are (the stationary phase is also a liquid, which the centrifugal force renders stationary). The rotor of the device consists of several rotor discs of the same diameter placed on each other and of a hollow column.

Patent application No. FR2883770A1 deviates from the former (EP1166100B1) in terms of the structure of the inside of the cells. According to the one embodiment, separation walls were created inside the cells in the radial direction. As a result of the separation walls the path taken by the liquid passing through the cell is substantially not straight, instead it follows the pathway created by the internal structure, thereby improving separation. According to the specification, in terms of their thickness, the walls must be as thin as possible, and their length must be slightly greater than half of the width of the cell. The device disclosed in the application makes liquid-liquid separation not only possible at the preparative scale but also at industrial scales. In connection with the solution in patent application No. FR2883770A1 it may be rightfully assumed that a significant proportion of the mixture to be separated is spread out on the cell wall, and with this the efficiency of the separation deteriorates.

Patent application No. U.S. Pat. No. 5,104,531A discloses an apparatus adapted for centrifugal separation and a method. One of the objectives of the invention is the creation of an advanced centrifugal apparatus as compared to the state of the art at the time, which contains a rotating spooled tube in the centrifugal force field for the separation of the dissolved materials. The spool is filled with a solid stationary phase, in other words this invention relates to a solid-liquid chromatography method.

Similarly to the above, patent application No. U.S. Pat. No. 4,051,025A discloses a continuous counter-current chromatography device, which device contains a spooled tube system rotating around a longitudinal axis.

Patent application No. U.S. Pat. No. 4,877,523A relates to an apparatus that is related to centrifugal counter-current partition chromatography. This apparatus is suitable for the testing, separation and purification of biochemical materials or natural organic compounds, i.e. for quantitative or qualitative analysis, and for the refining of raw samples. The apparatus contains a cylindrical rotor, which has a cell accommodating several cassettes. In terms of its topic, it is very similar to patent application No. JP56016868A2.

The object of patent application No. U.S. Pat. No. 4,551,251A relates to a monolithic integrated flow circuit, which is adapted for the transportation of liquids. The invention contains separation columns or channels for the separation of liquids according to conventional chromatographic principles, these are connected in series and are formed on a carrier matrix plate or sheet. Such matrix sheets are also used in analytics and preparative chemistry, and are particularly known of in the field of chromatographic separation and concentration.

The invention described in patent application No. US2009173680 relates to a continuous counter-current chromatographic system adapted for the separation and/or purification of materials. The essence of the invention is that it makes the counter-current chromatography known of at the time continuous. It solved the technical problem by arranging multiple inter-connected rotating cells in ring-like fashion on the dishes. The individual cells are connected to each other via liquid transport connections in such a way that the two liquids are transported in counter-current, the one liquid first passes through multiple cells then the liquid current is diverted back to the previous cells. Effective separation and good productivity may be achieved with this method, as the recycling of the sample to be separated is realised already during the process.

Patent application No. JP2005315787 presents a coiled column used for centrifugal partition chromatography. Up until patent application No. JP2005315787, the separation of polar material (particularly saccharides) was difficult even with a butanol/water solvent system. In other words, the objective was the creation of a separation column for a CPC system that makes efficient separation possible even in the case of butanol/water solvent. In actual fact, the column fitted to the apparatus consists of coil units connected in series located on a plate, which is then fitted into a partition chromatograph.

The object of patent application No. JPS629270A is a subunit that may be used in a centrifugal partition chromatograph. The rotor of the apparatus is cylindrical, along the circumference of which multiple so-called column cells are formed, and the neighbouring cells are connected to one another.

Patent application No. US2010200488A1 discloses a centrifugal partition chromatograph column that consists of discs placed on each other, which discs contain a network of three-dimensional cells connected in series.

Bianchi et al. used a type of continuous flow tubular reactor, the oscillatory flow reactor. Varying deflection sheet geometries are used in the tubular reactor, which ensure varying degrees of mixing. For example, deflection sheets may be helical in shape, however, in the case of this form of deflection sheet, insufficient mixing and stratification of the reaction components has been observed [Oscillatory flow reactors for synthetic chemistry applications, Journal of Flow Chemistry, 2020, 10, 475-490].

The objective of patent application No. WO2012172382A1 was the elaboration of a method and an apparatus that, in the case of column chromatography separation, prevents or reduces the loss in performance resulting from the radial inhomogeneity and wall effect of the chromatography column.

Patent No. U.S. Pat. No. 11,110,374B2 discloses a continuous counter-current spiral chromatography module with a spiral separator and its use, in which resin sludge is used for purification and which can be regenerated at the end of the method.

Nesme et al. strove to reduce foam formation occurring in connection with thermal separation processes [Helical Packing Columns for Preventing Foam Formation: Experimental and Numerical Investigations, Chemical Engineering & Technology, 2022, 45, 8, 1404-1413.]. Multiple spiral-shaped channels were created using 3D printing in the column(s) adapted for separation. The current in the channels is counter-current and the geometry of the channels exploits the stabilising effect of centrifugal force.

A centrifugal partition chromatography apparatus containing cells where there is an insert located in the cells designed to minimise the negative effects caused by Coriolis force more effectively than the solutions according to the prior art is not known of according to the state of the art. Therefore, the objective was set to provide a CPC apparatus the extraction cells of which contain an insert and the insert ensures efficient separation compared to the extraction cells and the inserts used in cells known of according to the state of the art.

The above objective was solved with a centrifugal partition chromatography apparatus in which helically shaped pieces were installed into the extraction cells as the insert. The role of the helical pieces according to the present invention in the extraction cells is to increase the phase interface surface area on which the material transfer between the phases takes place in chromatography, and thereby to increase the efficiency of the chromatographic separation as well.

In other words, the helical pieces located in the extraction cells are responsible for the efficiency of the chromatographic separation of the chromatography apparatus according to the present invention.

In addition, it was recognised that if sections of the helical pieces are broken off in a specific way and place, the efficiency of the chromatographic separation of the extraction cells is increased even more.

The advantage of the helical piece insert according to the present invention and placed in the extraction cells is that in this way the material transfer interface can be increased, thereby contributing to an increase in chromatographic efficiency. As it may be seen from the presentation of the prior art, it is preferable to use an insert in the extraction cells in order to increase the size of the material transfer interface. Inserts known of to date include, for example, metal mesh, steel wool, fibreglass and silica gel inserts. However, due to the lifetime of the above, the ability to clean them and, in certain cases, their crushing caused by centripetal force it is preferable to use the helical piece according to the present invention. Furthermore, a significant advantage of the present invention compared to the solutions according to the state of the art is that as a result of its structure the chromatography cell according to the present invention may be evenly increased in size, the volume of the helical piece located in the extraction cell is small (that is it does not significantly reduce the volume of the extraction cell) and the helical piece insert guides the liquid flowing during operation into a defined path in the extraction cell (the path of the liquid in the case of inserts according to the state of the art is not defined).

### SUMMARY

The object of the present invention relates to a helical piece shaped insert that may be used in a centrifugal partition chromatography extraction cell.

According to a preferable embodiment of the present invention the helical piece insert that may be used in a centrifugal partition chromatography extraction cell is made from a plate or a spring. According to an even more preferable embodiment of the invention the plate-formed helical piece insert contains break-offs on its side towards the extraction cell wall.

According to another preferable embodiment of the present invention the combined surface area of the break-offs of the helical piece used as the insert in the centrifugal partition chromatography extraction cell constitutes 20-40% of the cross-sectional area of the extraction cell.

According to yet another preferable embodiment of the present invention, the number of turns of the helical piece used in the centrifugal partition chromatography extraction cell is between 2 and 20.

The centrifugal partition chromatography extraction cell according to the present invention, which contains an insert formed as a helical piece, where the axial direction of the helical piece is substantially parallel to the longitudinal axis of the cell, and
a. the helical piece lies up against the wall of the centrifugal partition chromatography extraction cell at its part closer to the extraction cell wall; or
b. the helical piece is formed in such a way so that when the rotor containing the centrifugal partition chromatography extraction cell is rotating at the speed required for the given separation the helical piece rests up against the cell wall at its part closer to the extraction cell wall.

According to a preferable embodiment of the centrifugal partition chromatography extraction cell according to the present invention, the centrifugal partition chromatography extraction cell has a circular cross-section.

According to a preferable embodiment of the centrifugal partition chromatography extraction cell according to the present invention, the internal diameter of the circular cross-section extraction cell is between 3 mm and 200 mm.

According to a preferable embodiment of the centrifugal partition chromatography circular cross-section extraction cell according to the present invention, the length of the centrifugal partition chromatography extraction cell is between 30 mm and 300 mm.

According to another preferable embodiment of the centrifugal partition chromatography extraction cell, the L/D ratio of the centrifugal partition chromatography extraction cell is between 2.5 and 21.5, most preferably 3, where L is the length of the centrifugal partition chromatography extraction cell and D is the internal diameter of the centrifugal partition chromatography extraction cell.

The object of the present invention also relates to a rotor for centrifugal partition chromatography apparatus which contains the centrifugal partition chromatography extraction cells according to the present invention.

According to a preferable embodiment of the one or more rotors according to the present invention containing the centrifugal partition chromatography extraction cell, the number of centrifugal partition chromatography extraction cells per rotor is between 30 and 100, where the total length of the column is between 2.5 m and 4.1 m.

The object of the present invention also relates to a centrifugal partition chromatography apparatus that contains one or more rotors according to the present invention.

The object of the present invention also relates to a method for the production of the centrifugal partition chromatography extraction cell used in the centrifugal partition chromatography apparatus, during which the helical piece insert according to the present invention is placed in the inside of the extraction cell or the helical piece is formed in it.

According to a preferable embodiment of the method according to the present invention, a helical piece insert is placed inside the extraction cell or a helical piece shaped insert is created in it that has break-offs formed on its side towards the cell wall of a size so that during the separation the entire amount of the mobile phase falls through the break-offs.

### BRIEF DESCRIPTION OF THE DRAWINGS

FIG. 1 shows a block diagram of the structure of the centrifugal partition chromatography apparatus according to the present invention.

FIG. 2 shows a preferable embodiment of the helical piece that may be located as an insert in the centrifugal partition chromatography extraction cell to be found in the centrifugal partition chromatography apparatus.

FIG. 3 shows a schematic depiction of another preferable embodiment of the helical piece that may be located as a insert in the centrifugal partition chromatography extraction cell to be found in the centrifugal partition chromatography apparatus.

FIG. 4 shows a detail of the helical piece containing break-offs and used as the insert in the extraction cells.

FIG. 5 shows a centrifugal partition chromatography extraction cell containing a helical piece.

FIG. 6 shows a detail of a cross-section view of a centrifugal partition chromatography extraction cell containing a helical piece with break-offs.

FIG. 7 shows a schematic diagram of the descending mode of operation of an extraction cell.

FIG. 8 shows the result of a comparison of the tubular extraction cell disclosed in patent application No. EP3204136A1 and the centrifugal partition chromatography extraction cell according to the present invention containing helical piece in connection with the separation of parabens.

FIG. 9 shows the result of a simulation calculation performed on a plate-formed helical piece insert.

FIG. 10 shows a cross-section view of the connection between an extraction cell containing a plate-formed helical piece insert and the feed opening of a plug placed on this.

### DETAILED DESCRIPTION

Within the context of the present specification if a numerical value is given, it should be understood as meaning that the last digit of the given number shows the accuracy of the given value in accordance with the rules of rounding. In other words, for example, 99.1% is understood to mean the range of 99.05% to 99.14%.

In the case of liquid-liquid chromatography methods (LLC) both the stationary phase and the mobile phase are liquids, which liquids are not substantially miscible. The distribution of the components of the sample to be separated among the two phases differs, the transfer of material takes place at the interface between the two phases (stationary and mobile phases).

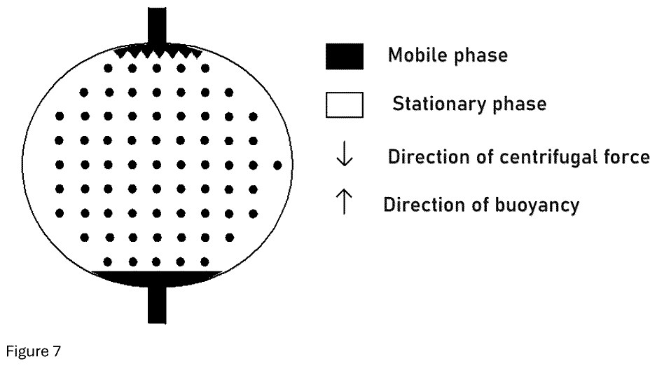

Chromatography is called ascending chromatography when the stationary phase is the denser phase and the mobile phase is the less dense phase, in such a case the mobile phase flows from the rotational circumference towards the rotational centre. Descending chromatography is when the stationary phase is the less dense phase and the mobile phase is the denser liquid phase, in such a case the mobile phase flows from the rotational centre towards the rotational circumference. FIG. 7 shows a schematic view of a centrifugal partition chromatography extraction cell operating in descending mode and not containing an insert. The centrifugal partition chromatography extraction cell operating in descending mode may be divided into three parts from the point of view of the mobile phase:
a) the upper part of the centrifugal partition chromatography extraction cell: if the linear flow rate of the incoming liquid is greater than that permitted by Stoke's law on the basis of the physical-chemical parameters of the two phases and the current field of force, then the mobile phase disintegrates into tiny droplets in the stationary phase, and then, in an ideal case, the droplets are distributed homogenously throughout the cross-section of the centrifugal partition chromatography extraction cell;
b) the middle part of the centrifugal partition chromatography extraction cell: the droplets of the mobile phase flow through the stationary phase, due to the greater centrifugal force exerted on them, the stationary and the mobile phase come into contact with each other over a large surface area in the middle part of the centrifugal partition chromatography extraction cell; in an ideal case the two phases are in contact with each other from the inlet point nearly up until the outlet point;
c) the lower part of the centrifugal partition chromatography extraction cell: here the contraction of the centrifugal partition chromatography extraction cell may be observed, due to the difference in density between the two phases they separate from each other, the lower density phase being forced upwards due to the Archimedes buoyancy force, while the greater density phase continues to be forced downwards due to the greater centrifugal force exerted on it; in an ideal case the mobile phase resides in the stationary phase in small droplets and not in coagulated clumps, and only the mobile phase leaves the extraction cell.

If the sample solution to be separated is fed into the liquid flow using the sample injector into the rotor of the centrifugal partition chromatography apparatus in the form of a plug (which corresponds to laminar flow), then by passing through a series of centrifugal partition chromatography extraction cells, the components with differing partition coefficients becomes separated from each other. It is obvious for a person skilled in the art that following the aforementioned injection of the sample plug, the laminar flow is more momentary/a status existing for a short amount of time in the centrifugal partition chromatography apparatus. Introducing a precise aliquot of a sample solution in the shortest possible injection time has a preferable effect on the peak width of the eluting peaks (in separation it is of key importance for the peaks to remain as narrow as possible, and for them not to become wider), in other words the plug-like sample injection also ensures that the initial peak width and with this the eluting peak width are as narrow as possible. The role of laminar flow is also to reduce the undesired widening of the peaks during separation in centrifugal partition chromatography, which is also due to the mixing taking place during the chromatography process. The separation results from the fact that the propensity for the material transfer (sorption/desorption) of the components in the solution with different partition coefficients between the mobile and the stationary phases at the phase interface surface is different, so they spend different amounts of time in the individual phases. In other words, the efficiency of the chromatographic separation largely depends on the size of the material-transfer surface between the two phases. In other words, if the size of the material-transfer surface is increased, then the chromatographic efficiency will also increase.

Those liquid-liquid chromatography methods in which the stationary phase is created from liquid solvent or multi-component solvent mixtures as a result of the centrifugal force field, and in which the mobile phase is a liquid are called centrifugal partition chromatography methods, which may be abbreviated as CPC. A device that uses a centrifugal force field for separation (purification) is a centrifugal partition chromatography apparatus. In the context of the present invention the series of extraction cells located in the centrifugal partition chromatography apparatus is responsible for the chromatographic separation.

In the context of the present invention a centrifugal partition chromatography extraction cell is that usually cylindrically shaped chamber delimited by a cell wall containing one or more inlet and outlet openings in which the two phases are mixed and, thereby, the separation of the components of the sample takes place in such a way that the distribution of the components is different among the two phases. Cylindrically shaped is understood to mean a circular based cylinder, the height of which is preferably at least twice the length of the radius of the circular base, and even more preferably three times its length. The centrifugal partition chromatography extraction cells may be made from the following materials: stainless and acid resistant steel; PTFE; PVDF; PEEK; HDPE; titanium; graphite and carbon fibre composites. The approximate maximum pressure value that the centrifugal partition chromatography extraction cell according to the invention can withstand is 150 bar, during operation the operating pressure value is usually between 20 and 50 bar. As is known to a person skilled in the art series-connected centrifugal partition chromatography extraction cells are linked to each other with lines suitable for the transportation of liquids, in other words the cells have outlet and inlet openings. A series of cells set up in this way is adapted for solvents at high pressure being made to flow through it.

In other words, a significant advantage of the solution according to the present invention compared to centrifugal partition chromatography apparatuses according to the state of the art is that it may be operated at a lower pressure but with the same efficiency than those extraction cells where the cells and the lines that connect them are engraved in a plate and these plates are bolted together with the use of seals. Therefore, it is preferable if the extraction cells and the lines, preferably larger diameter lines, connecting them are fitted together via a heat treatment process, for example, instead of bolts, because in this way the device may be operated at a lower pressure. The reason for this is that if the lines have a greater diameter, then the flow in the tube is laminar (without turbulence). This latter feature and the use of fewer cells with a greater level of efficiency result in a lower operating pressure.

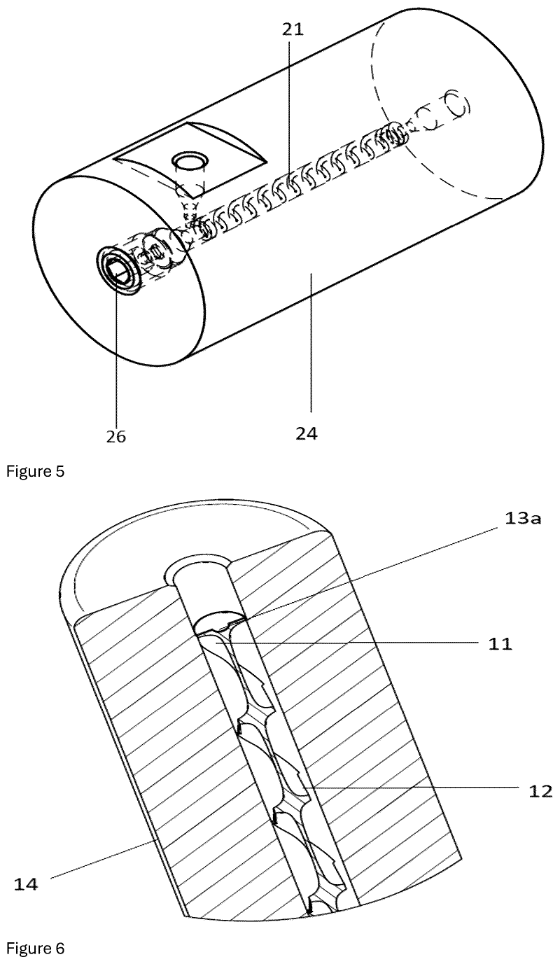

In accordance with the present invention the centrifugal partition chromatography extraction cell contains a helical piece insert. During the implementation of a centrifugal partition chromatography operation performed with a cell without an insert the flow is not laminar at every point in the extraction cells, this results in turbulent flow in the interior of the centrifugal partition chromatography extraction cell, thereby causing back-mixing, which is a negative effect from the aspect of the efficiency of chromatographic separation. The reason for this is that such back-mixing may mix together the separated materials once again, thereby reducing the efficiency of separation. In addition, during the separation operation as great a possible magnitude of surface contact must be achieved between the two liquid phases in the interest of increasing the efficiency of surface material transfer. The helical piece (see FIGS. 5 and 6) placed in the centrifugal partition chromatography extraction cell reduces the negative effect caused by the aforementioned back-mixing. In addition to back-mixing a negative effect caused by tangential force is that the material flow arriving into a centrifugal partition chromatography extraction cell without an insert is diverted towards the wall of the extraction cell. The diverted flow of material is precipitated on the cell wall and then coagulates into larger droplets. The larger the droplets, the smaller their specific surface area. In addition, the liquid surface in contact with the cell wall (this is understood to mean the newly created, larger droplets precipitating on the cell wall) does not come into contact with the other liquid phase. In other words when the small droplets coagulate into larger droplets and due to coming into contact with the wall, the size of the material transfer surface of the droplets is reduced, which is not preferable in the case of chromatographic separation. This is because in chromatography the greater the size of the material transfer interface, the better the efficiency of separation. In other words, if the size of the material transfer interface within the extraction cell is sufficiently increased, then fewer centrifugal partition chromatography extraction cells are sufficient to achieve the same level of separation efficiency. The use of fewer centrifugal partition chromatography extraction cells is preferable because through this the pressure drop on the rotor is lower. An unexpected recognition according to the present invention was that by using a helical piece in the cell as an insert the negative effects of tangential force can be reduced, by increasing the specific surface area as a result of the insert the size of the material transfer interface increases, and so, ultimately an extraction cell containing such a helical piece will produce more efficient separation. In other words, within the context of the present invention, insert is not only understood to mean a material or elements that fills the entire volume of the extraction cell, but also that insert that fills it only partially.

Therefore, the task of the helical piece insert placed in the centrifugal partition chromatography extraction cell is multiple: it prevents the diversion of the material flow caused by tangential force in the direction of the cell wall, compared to a cell of the same size but without an insert, the insert increases the specific surface area in the centrifugal partition chromatography extraction cell, and thereby the size of the material transfer interface also increases; and it overcomes the back-mixing caused by turbulent flow within the centrifugal partition chromatography extraction cell. The helical piece shaped insert is geometrically well defined, and so its shape may be designed and, thereby, the effect elicited by it can also be designed. The helical piece shaped insert according to the present invention is preferable compared to the known inserts because it does not become deformed and remains stable even when centripetal force is exerted on it during rotation. As opposed to this, for example, a metal wool insert according to the state of the art used in a centrifugal partition chromatography extraction cell collapses due to the effect of the centripetal force created during rotation, thereby it can only exert its effect in a part of the volume of the cell. In addition, the conventional inserts mentioned above may also cause an increase in pressure in the extraction cell, while the helical piece shaped insert does not cause an increase in pressure. The helical piece shaped insert exerts its effect in two ways, on the one part it re-atomises the coagulated larger droplets, and, on the other part, it increases the length of the pathway within the cell-both effects increase the specific surface area. The cleaning of centrifugal partition chromatography extraction cells with glass wool or steel wool inserts (these inserts are not geometrically defined) using a rinse-through technique is less efficient than in the case of the helical piece shaped inserts according to the present invention due to their large surface area, numerous flow paths, dense material structure and their blind spots. Each of the extraction cells contain just one helical piece shaped insert, during cleaning the solvent used for cleaning flows through the entire volume of the extraction cell without any blind spots, thereby, on the one part, the solvent demand for cleaning is lower, the insert, due to its structure, may be replaced, so the extraction cells can be cleaned individually as well. In the case of silica gel inserts frequently used according to the state of the art, there is also the issue of the regeneration of the silica gel insert.

Overall, it may be stated that with the use of the helical piece insert according to the present invention, the use and manufacture of a centrifugal partition chromatography apparatus becomes faster and more cost-efficient.

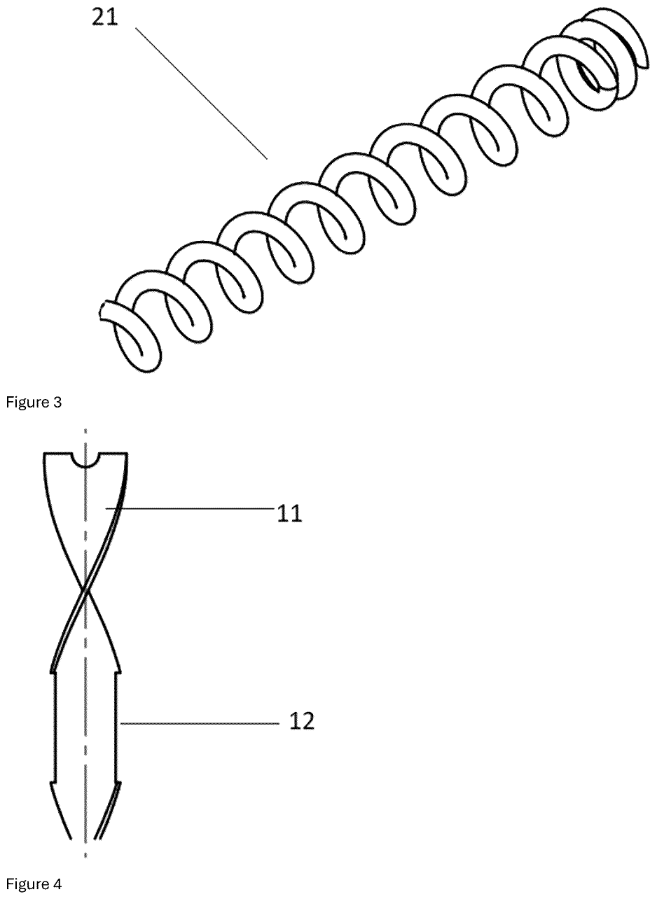

In accordance with the present invention, the helical piece shaped insert has two preferable structures, the plate-formed helical piece 11 (FIG. 2) and the spring-formed helical piece 21 (FIG. 3) (the latter of which serves for the schematic presentation of the embodiment irrespective of the number of turns).

The helical shaped piece according to the present invention, which the centrifugal partition chromatography extraction cell contains, is preferably made from plate material. The plate-formed helical piece 11 increases the internal interface of the centrifugal partition chromatography extraction cell compared to the interface of extraction cells without an insert. The plate-formed helical piece 11 is illustrated in FIG. 2. The plate-formed helical piece 11 may be imagined in the simplest way in that a rectangular plate is secured at both its ends and the one end is rotated in the plane perpendicular to the plane of the plate and parallel to shorter side of the plate. The number of the imagined rotations is proportionate to the number of turns of the helical piece. (The rotation operation described above only serves as an illustration, the plate-formed helical piece according to the invention may also be produced in other ways.) Semi-circular cut-outs 13a and 13b may be seen at the ends of the plate-formed helical piece 11 according to FIG. 2. The purpose of these is to provide a pathway for the liquid fed into the centrifugal partition chromatography extraction cell, as the feed opening 15 (FIG. 10) of the plug for feeding the liquid into the cell rests up against the edge of the plate-formed helical piece 11. For example, in the case of a cell with a length of 30 mm the radius (R) of the semi-circular cut-outs 13a and 13b may be 0.25 mm. As the liquid feed opening is located above the semi-circular cut-out 13a and 13b, about a half of the input liquid will flow on one side of the plate-formed helical piece 11, and about another half will flow on the other side of the plate-formed helical piece 11.

According to another preferable embodiment the helical piece is a spring-formed helical piece 21, a schematic view of which may be seen in FIG. 3. Here the input mixture to be separated arrives at around the centre of the spring structure and the force originating from the rotation directs it to the surface of the spring.

According to a preferable embodiment of the helical piece shaped insert according to the invention, it is formed as a spring (marked with reference sign 21). The flexible spring structure of the helical piece makes it possible for the helical piece to rest up against the internal surface of the centrifugal partition chromatography extraction cell 24 during operation due to the effect of centripetal force, in other words when the rotor is rotating at a given speed (the radius of the spring-shaped piece grows to the extent permitted by the cell wall). Due to this the spring-formed helical piece 21 and the internal surface of the centrifugal partition chromatography extraction cell 24 do not have to fit perfectly in rest state (FIG. 5), therefore the production of such an extraction cell is simpler, the positioning of the spring-formed helical piece 21 into the centrifugal partition chromatography extraction cell 24 is simpler, and spring-formed helical pieces 21 manufactured subsequently can be easily adapted for existing extraction cells. The plug 26 for feeding the liquid into the centrifugal partition chromatography extraction cell 24 is indicated in FIG. 5.

The efficiency of chromatographic separation may be further increased by breaking off the side of the plate-formed helical piece 11 closer to the wall of the centrifugal partition chromatography extraction cell (see FIG. 4). As a result of break-offs 12 of the plate-formed helical piece 11 insert, after the liquid flow has passed through the break-off 12 it once again gets into the stationary phase, thereby increasing the phase interface between the stationary and mobile phases.

Increasing the phase interface in chromatographic separation is of key importance, as it is via this that the material transfer takes place (sorption/desorption), in other words the greater the size of the interface between the phases, the better the efficiency of separation. On the basis of preliminary model experiments, the structure of the centrifugal partition chromatography extraction cell 14 according to the present invention, as a result of the plate-formed helical piece 11 with break-offs 12 located in it, increased the area of the phase interface by 46% compared to the surface area of the phase interface of an extraction cell without an insert. It should be noted that the area of an interface measured in a cylindrical extraction cell without an insert where the solvent system used was ethyl acetate-water is taken as 100%.

The break-offs 12 of the plate-formed helical piece 11 are understood to mean lacks of continuity of the aforementioned helical piece. The lack, i.e. the break-off 12 is understood to mean cut-outs/gaps created in the surface of the plate-formed helical piece 11, which are located close to the wall of the centrifugal partition chromatography extraction cell 14 (FIG. 6).

The helical piece containing break-offs 12 according to the present invention contain one or more, preferably two break-offs 12 per turn (i.e. per complete turn of the helical piece).

The combined surface area of the break-offs 12 of the plate-formed helical piece 11 used as an insert in the centrifugal partition chromatography extraction cell according to the present invention constitutes 20% to 40% of the cross-sectional surface area of the extraction cell. The optimal size of the break-offs 12 of the centrifugal partition chromatography extraction cell (i.e. the size of the broken off surface) is determined by the flow rate used in the centrifugal partition chromatography apparatus. The better the separation efficiency, the greater the proportion of mobile phase that passes through the break-offs 12. The break-offs 12 of the helical piece reduce the negative effects of Coriolis force created during operation in the centrifugal partition chromatography extraction cell(s) by the fact that the liquid flow does not flow along the cell sidewall, instead because of the break-offs 12 the liquid flows through them. In other words, the break-offs 12 of the plate-formed helical piece 11 are designed to reduce the turbulent flow and back-mixing caused by the Coriolis force as phenomena having a negative effect on separation.

The number of turns of the helical piece used as an insert in the centrifugal partition chromatography extraction cell according to the present invention is between 2 and 20 (the number of turns of the plate-formed helical piece shown in FIG. 2 is 3). The range of the number of turns being between 2 and 20 is derived from the size of the centrifugal partition chromatography extraction cell; it was experimentally determined that if, for example, the number of turns is increased from 4 to 5 (for this we used two sample extraction cells as the basis with a diameter of 10 mm and a length of 32 mm) then increasing the number of turns by one increased the interface surface area of the helical piece by 4%. From this it may also be concluded that increasing the number of turns above a certain limit no longer improves the efficiency of separation, due to this it is not worthwhile using more than 20 turns. Nevertheless, the use of a number of turns in excess of 20 does not damage the efficiency of the extraction cell.

Now the centrifugal partition chromatography extraction cell according to the present invention will also be presented within the context of the present invention, which extraction cell contains the helical piece insert 11 or 12 characterised in detail above (FIGS. 5 and 6). The helical piece insert 11 or 21 is positioned in the centrifugal partition chromatography extraction cell 14 or 24 in such a way that the direction of the axis of the helical piece 11 or 21 is substantially parallel to the longitudinal axis of the centrifugal partition chromatography extraction cell 14 or 24. According to one possibility of the helical piece insert, so when the plate-formed helical piece 11 is used, its part closer to the extraction cell wall rests on the wall of the centrifugal partition chromatography extraction cell, with this and its helical shape it guides the liquid flow in the extraction cell, preventing the liquid flow flowing on the extraction cell wall, thereby sufficiently increasing the material transfer surface area within the centrifugal partition chromatography extraction cell. According to the other possibility, in other words when the spring-formed helical piece 21 is used, the helical piece is formed so that when the rotor containing the centrifugal partition chromatography extraction cell is rotating at the speed of rotation required for the given separation, the helical piece rests up against the part of the extraction cell wall closer to it. It should be noted that the form of the shape of the centrifugal partition chromatography extraction cells may deviate from the cylindrical design mentioned above with the stipulation that it must be possible to position the helical piece according to the invention inside the cell in the way described earlier.

The centrifugal partition chromatography extraction cell preferably has a circular cross-section. The internal diameter (D) of the centrifugal partition chromatography extraction cell with circular cross-section is preferably 3 mm to 200 mm.

The length (L) of the centrifugal partition chromatography extraction cell according to the present invention is preferably between 30 mm and 300 mm.

The circular cross-section is preferable because this cell geometry makes it possible to easily insert/create the helical piece 11 or 12 in the cell. For example, the internal diameter of a centrifugal partition chromatography extraction cell with a circular cross-section used for analytical purposes is between 3 mm and 20 mm, and its length is between 30 mm and 110 mm, and as it has analytical dimensions, it is suitable for separating samples with a weight of the order of milligrams. The diameter of a centrifugal partition chromatography extraction cell according to the present invention with a circular cross-section of a size for use for preparative purposes is between 20 mm and 200 mm, its length is between 110 mm and 300 mm, as a result of its size it is suitable for separating samples in the order of a gram.

The L/D ratio of a centrifugal partition chromatography extraction cell according to the present invention (for details see below) is at least 2, and preferably between 2.5 and 21.5.

It is obvious for a person skilled in the art that the centripetal force has an effect on the flow of material travelling through the centrifugal partition chromatography extraction cell, as a result of which the sample travels along the entire length of the extraction cell; on the other part tangential force also has an effect on it, as a result of which the flow of material collides with the wall of the extraction cell and then coagulates there into larger droplets (the specific surface area of these is smaller). If the length of the extraction cell is increased too much, then the pathway that is not preferred from the point of view of the efficiency of separation would be increased, in addition to that, with the extension of the length of the extraction cells, the pressure in the centrifugal partition chromatography extraction cells also increases, which pressure would obstruct the flow of the liquid. At the same time, it is necessary to increase the length of the extraction cell with consideration to its effect exerted on pressure, also with consideration to the fact that there may be a technical limit in this respect to the centrifugal partition chromatography extraction cell according to the present invention.

As a result of the structure of the centrifugal partition chromatography extraction cell according to the present invention it may be operated in both so-called ascending and descending modes without any refitting being necessary, as the cell design itself is symmetrical. Furthermore, it is precisely because of the symmetrical structure of the centrifugal partition chromatography extraction cell that it does not have to include a component at the input part of the extraction cell serving for distribution of the liquid flow and at the outlet part of the extraction cell for the collection of the liquid flow, the collection of the liquid flow is ensured by the joint structure of the helical piece 11 or 12 and the extraction cell.

The object of the present invention also relates to a rotor that may be used for the centrifugal partition chromatography apparatus, which rotor contains the centrifugal partition chromatography extraction cells according to the present invention. The centrifugal partition chromatography extraction cells located on the rotor are connected in series to one another. The extraction cells are arranged on the rotor of the centrifugal partition chromatography apparatus in such a way that they rotate around the axis of the rotor. By positioning the series of cells on the rotor in a circular shape and then by rotating it the appropriate material transfer between the phases is achieved. As a consequence of the rotation tangential force is created in the centrifugal partition chromatography extraction cells, due to the effect of which the jet of mobile phase entering the extraction cell is diverted. As a result of this the droplets of the mobile phase are forced up against the sidewall of the cell in the case of a cell not containing an insert, and so in this way the size of the interface established with the stationary phase is reduced. The helical piece according to the present invention reduces this unfavourable effect to a large extent, as the structure of the insert in the shape of a helical piece does not permit the mobile phase to flow along the wall of the extraction cell, instead it diverts it in the direction of the opposite cell wall, thereby improving the contact between the stationary and mobile phases.

The number of centrifugal partition chromatography extraction cells on the rotor containing centrifugal partition chromatography extraction cells is preferably between 30 and 100, where the total height of the column is between 2.5 m and 4.1 m. It is obvious for a person skilled in the art that the higher the number of centrifugal partition chromatography extraction cells, the better the separation efficiency, or the more efficient the centrifugal partition chromatography extraction cells that are used are, the fewer the number of extraction cells are required. A minimum of 30 centrifugal partition chromatography extraction cells are recommended to be arranged on a rotor. At the same time there is an upper limit to the increase in the number of extraction cells, which upper limit may be determined empirically. One reason for the upper limit is that more extraction cells means more tubes that connect them together, which would result in greater operating pressure and a lower load capacity. A rotor with more than 100 extraction cells would not increase the efficiency of chromatographic separation significantly, however this would make the setting up of the rotor exceptionally difficult and its costs would rise significantly.

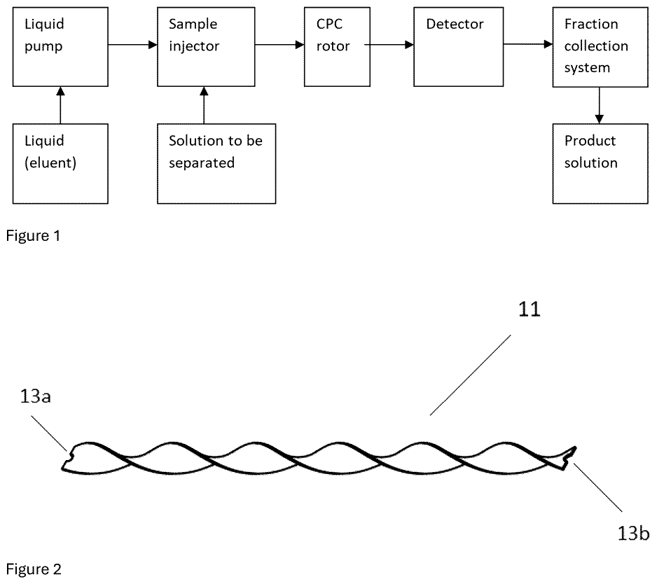

The object of the present invention also relates to the centrifugal separation chromatography apparatus, which contains one or more rotors according to the present invention, in other words rotors that contain the centrifugal partition chromatography extraction cells according to the present invention connected in series. The components of the centrifugal separation chromatography apparatus are illustrated in the block diagram in FIG. 1.

During the method for the production of the centrifugal separation chromatography extraction cell that may be used in the centrifugal separation chromatography apparatus according to the present invention, the helical piece insert according to the present invention is positioned or created inside the extraction cell. Creation in this case is understood to mean that the helical piece insert is formed in an irreversibly fixed way in the extraction cell when the extraction cell is produced (using 3D printing, for example). In this case positioning is understood to mean that there is the possibility to position the helical piece in a removable (reversible) way.

During the method for the production of the centrifugal separation chromatography extraction cell that may be used in the centrifugal separation chromatography apparatus, a helical piece insert may also be positioned in the extraction cell that contains break-offs 12 on the side closer to the cell wall. The break-offs 12 in the plate-formed helical piece 11 may be found per turn on the side closer to the cell wall under each other (FIG. 6). The positioning and size of the break-offs 12 of the plate-formed helical piece 11 insert are preferably such so that all the liquid flowing in the centrifugal partition chromatography extraction cell 14, in other words essentially the entire amount of the mobile phase falls to the level of the next turn of the plate-formed helical piece 11 insert. This phenomenon is preferable because the flowing liquid does not simply flow on the wall of the extraction cell or along a helical path in the interior of the extraction cell, instead the flowing liquid follows the helical path supplemented with short straight sections as a consequence of falling through to the next turn per turn in the centrifugal partition chromatography extraction cell according to the present invention, thereby interrupting the regular helical path. In other words, via the positioning and structure of the break-offs 12 the negative effect of the tangential force developing as a consequence of the rotational movement is minimised.

The rotor containing centrifugal partition chromatography extraction cells according to the present specification is used for centrifugal partition chromatography separation in centrifugal partition chromatography apparatus.

The invention is disclosed in the following with reference to figures.

### Example 1: The Separation of a Mixture of Ethylparaben and Methylparaben Using Centrifugal Partition Chromatography in a Centrifugal Partition Chromatography Apparatus Containing the Centrifugal Partition Chromatography Extraction Cells According to the Invention

A 100 μg mixture containing ethylparaben and methylparaben was separated, in which the ratio of ethylparaben and methylparaben was 50-50 mass % (Sigma-Aldrich, methylparaben CAS: 99-76-3; Sigma-Aldrich, ethylparaben CAS: 120-47-8). The mixture of ethylparaben and methylparaben was dissolved in 50 μl of stationary phase of a solvent mixture in equilibrium (for composition see below) for injection.

The parameters of the centrifugal partition chromatography separation were as follows:
The ratios of the composition of the solvent mixture in equilibrium are the following (please note that the solvent mixture was brought into equilibrium by shaking the stationary and mobile phases together):
hexane: 135;
ethyl acetate: 15;
acetonitrile: 60;
water: 240;
phosphoric acid: 0.1.
Stationary phase retention during the chromatographic separation: 91%.
Centrifugal partition chromatography apparatus mode of operation: descending.
Speed of rotation of the rotor of the centrifugal partition chromatography apparatus: 1000 rpm.
Flow rate used in the centrifugal partition chromatography extraction apparatus: 1 ml/min.
Operating pressure in the centrifugal partition chromatography extraction apparatus: 20 bar.
Number of centrifugal partition chromatography extraction cells: 80.
Dimensions of the centrifugal partition chromatography extraction cell, centrifugal partition chromatography extraction cell diameter: 4 mm,
Centrifugal partition chromatography extraction cell length: 40 mm,
Number of turns of the helical piece insert: 4
Helical piece form: plate
Temperature during the chromatographic separation: room temperature.

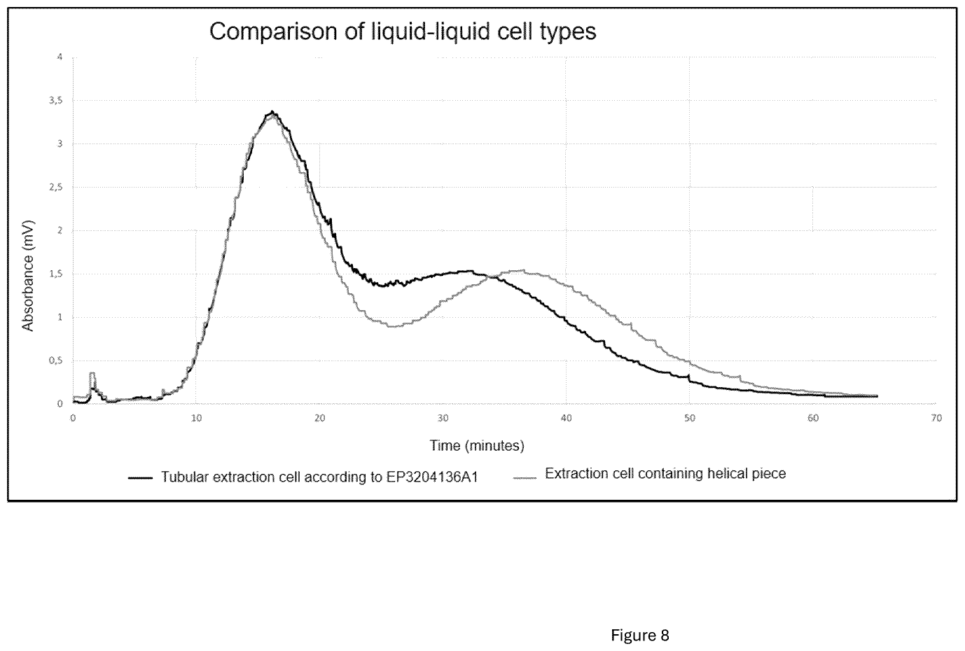

The above separation was also performed in the centrifugal partition chromatography apparatus containing tube-structure extraction cells disclosed in patent application number EP3204136A1. During the comparison the above parameters were the same, the two centrifugal partition chromatography extraction apparatuses differed in terms of the insert in the extraction cells. The result of the comparison tests may be seen in FIG. 8. On the basis of the graph in FIG. 8 it may be clearly seen that the separation of the components of the mixture containing ethylparaben and methylparaben was better in the centrifugal partition chromatography extraction apparatus containing the helical piece, which is also supported by the numerical data, see the data in table 1:

TABLE 1

| | Main fractions | HPLC purity: | Yield: |
|---|---|---|---|
| EP3204136A1, | methylparaben | 99.13% | 75.95% |
| tube extraction cell | ethylparaben | 99.03% | 84.36% |
| Extraction cell | methylparaben | 99.19% | 78.18% |
| containing helical piece | ethylparaben | 99.09% | 86.16% |

It may be clearly seen from the data shown in the table that the yield of both the ethylparaben and the methylparaben was better by nearly 2% in the case of the centrifugal partition chromatography extraction apparatus according to the present invention which contains centrifugal partition chromatography extraction cells containing plate-formed helical piece inserts.

### Example 2—Simulation

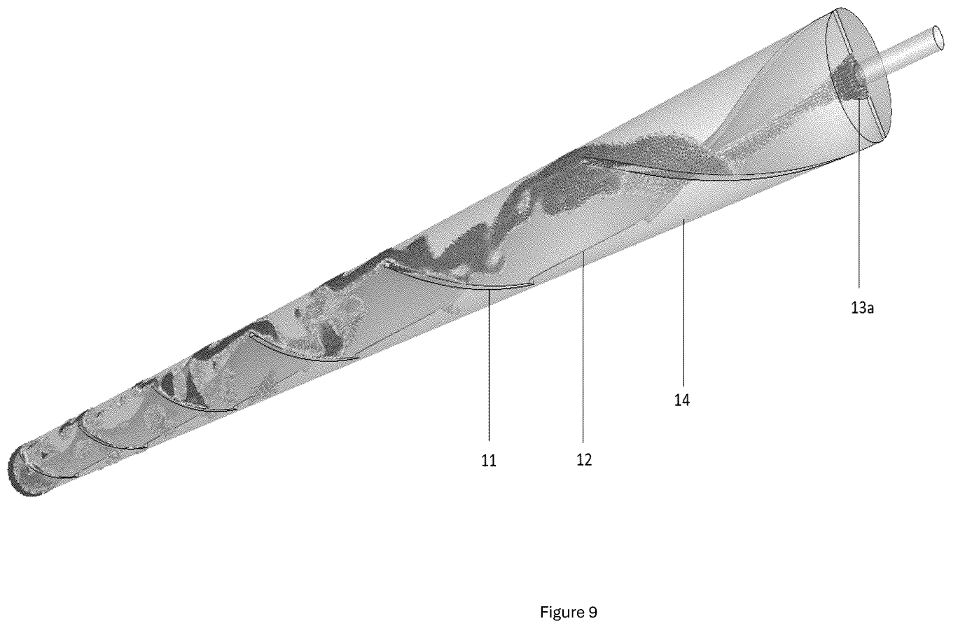

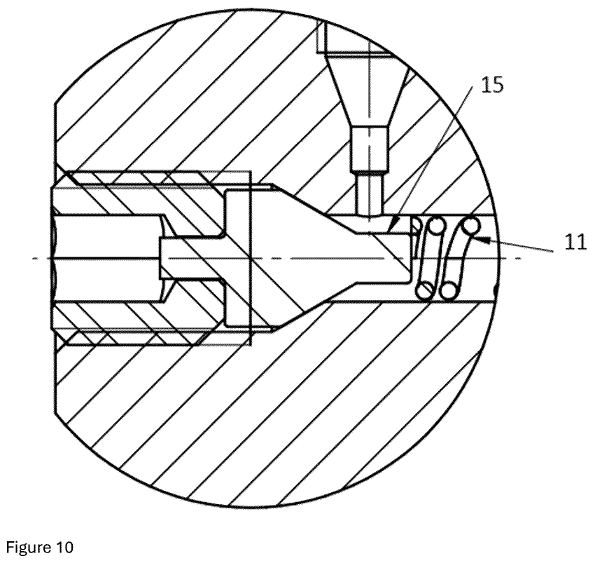

FIG. 9 shows the result of the computer simulation during which a plate-formed helical piece insert 11 containing break-offs 12 was examined.

The parameters of the simulation were as follows:

### Reference Test: Without Insert

Centrifugal partition chromatography extraction cell diameter: 1.5 mm.

Centrifugal partition chromatography extraction cell length: 30 mm.

Solvent mixture at equilibrium: ethyl acetate/water

Centrifugal partition chromatography apparatus mode of operation: ascending.

Speed of rotation of the rotor of the centrifugal partition chromatography apparatus: 1200 rpm.

Flow rate used in the centrifugal partition chromatography extraction apparatus: 2 ml/min.

Specific interface surface area of the centrifugal partition chromatography extraction cell: 100%.

Measurement with Centrifugal Partition Chromatography Extraction Cell Containing a Helical Piece:

Centrifugal partition chromatography extraction cell diameter: 1.5 mm.

Centrifugal partition chromatography extraction cell length: 30 mm.

Number of turns of helical piece insert: 5.

Helical piece form: plate

Solvent mixture at equilibrium: ethyl acetate/water.

Centrifugal partition chromatography apparatus mode of operation: ascending.

Speed of rotation of the rotor of the centrifugal partition chromatography apparatus: 1200 rpm.

Flow rate used in the centrifugal partition chromatography extraction apparatus: 2 ml/min.

Specific interface surface area of the centrifugal partition chromatography extraction cell: 195%.

In other words, on the basis of the simulation presented in the above example 2 it may be clearly seen that the size of the specific interface surface area is increased by 95% if a plate-formed helical piece is used during the separation as insert in the centrifugal partition chromatography extraction cell.

The maximum pressure capacity of the centrifugal partition chromatography extraction cells according to the invention is approximately 150 bar, in other words they can withstand more pressure than the centrifugal partition chromatography extraction cells known of to date. This is due, on the one part, to the fact that the individual components are fitted to each other using a thermal treatment process, and the resistance to pressure is also contributed to by the fact that the size of the specific interface surface area was increased inside the centrifugal partition chromatography extraction cell, and this results in that fewer centrifugal partition chromatography extraction cells result in efficient separation, in other words the fewer centrifugal partition chromatography extraction cells results in a lower drop in pressure. Compared to the centrifugal partition chromatography extraction cells belonging to the state of the art, in the centrifugal partition chromatography extraction cells according to the invention there is no need for a component at the input part of the extraction cells serving for distribution of the liquid flow and at the outlet part of the extraction cell for the collection of the liquid flow. In other words, overall, the centrifugal partition chromatography extraction cell according to the present invention consists of fewer components, therefore the structure of the centrifugal partition chromatography apparatus is simpler, so its manufacture will be simpler and, therefore, faster and more cost-efficient. The use of the helical piece insert located in the centrifugal partition chromatography extraction cell according to the invention is preferable because it prevents the diversion of the material flow caused by tangential force in the direction of the cell wall; due to its design it increases the size of the material transfer surface in the centrifugal partition chromatography extraction cell; it prevents the back-mixing caused by turbulent flow within the extraction cell, in other words as a result of the use of the helical piece insert the efficiency of chromatographic separation increases. The efficiency of chromatographic separation increases further if the parts of the helical piece insert closer to the wall of the centrifugal partition chromatography extraction cell are broken off, thereby facilitating the flow of the mobile phase.

An important advantage of the helical piece insert used in the centrifugal partition chromatography extraction cell according to the present invention is that the helical piece remains stable even when affected by centripetal force, its lifetime is longer, and, in addition, it is easy to clean. The helical piece insert may be clearly geometrically defined and designed, and due to this the effect of the insert can also be clearly defined and measured. The helical piece insert re-atomises the larger sized droplets coagulating during the separation process and, due to its structure, it increases the length of the path taken by the sample during separation, thereby increasing the size of the specific interface between the phases. Furthermore, an advantage of a centrifugal partition chromatography apparatus with such a helical piece insert is that its dimensions can be more easily increased and scaling of production is simpler. The ratio of stationary and mobile phases formed in the centrifugal partition chromatography cells according to the present invention is at least 80%, in addition the greater the size of the specific interface between the stationary and mobile phases, the more efficient the separation. This objective may be also achieved with the use of extraction cells that contain a helical piece as insert.

The centrifugal partition chromatography cell according to the present invention is completely symmetrical, so it may be used in both ascending and descending modes without any need for refitting, a result of this is that its operation is simpler. There is no need for refitting when switching between the individual operation modes (ascending-descending), which significantly reduces the down-time of the apparatus, and so increases productivity.

1. Insert (11, 21) for use in a centrifugal partition chromatography extraction cell (14, 24), wherein the insert is formed as a helical piece.

2. Insert (11, 21) for use in a centrifugal partition chromatography extraction cell (14, 24) according to claim 1, wherein the helical piece insert is plate-formed (11) or spring-formed (21).

3. Plate-formed helical piece insert (11) for use in a centrifugal partition chromatography extraction cell (14) according to claim 2, wherein the plate-formed helical piece insert (11) contains break-offs (12) on the side close to the extraction cell wall.

4. Plate-formed helical piece insert (11) containing break-offs (12) for use in a centrifugal partition chromatography extraction cell (14) according to claim 3, wherein the combined surface area of the break-offs (12) of the helical piece used as insert constitutes 20% to 40% of the cross-sectional surface of the centrifugal partition chromatography extraction cell (14).

5. Helical piece insert (11, 21) for use in a centrifugal partition chromatography extraction cell (14, 24) according to claim 1, wherein the number of turns in the helical piece insert is between 2 and 20.

6. A centrifugal partition chromatography extraction cell (14, 24), comprising helical piece insert (11, 21) of claim 1, where the axial direction of the helical piece is substantially parallel to the longitudinal axis of the cell, and
a. the helical piece lies up against the wall of the centrifugal partition chromatography extraction cell at its part closer to the extraction cell wall; or
b. the helical piece is formed in such a way so that when the rotor containing the centrifugal partition chromatography extraction cell is rotating at the speed required for the given separation the helical piece rests up against the cell wall at its part closer to the extraction cell wall.

7. The centrifugal partition chromatography extraction cell (14, 24) according to claim 6, wherein the cell has a circular cross-section.

8. Centrifugal partition chromatography extraction cell (14, 24) according to claim 7, wherein the internal diameter of the circular cross-section cell is between 3 mm and 200 mm.

9. Centrifugal partition chromatography extraction cell (14, 24) according to claim 7, wherein its length is between 30 mm and 300 mm.

10. Centrifugal partition chromatography extraction cell (14, 24) with cross-section according to claim 7, wherein its L/D ratio is between 2.5 and 21.5, where L is the length of the centrifugal partition chromatography extraction cell (14, 24) and D is the internal diameter of the centrifugal partition chromatography extraction cell (14, 24).

11. A rotor for centrifugal partition chromatography apparatus; comprising the centrifugal partition chromatography extraction cell (14, 24) according to claim 6.

12. The rotor for centrifugal partition chromatography apparatus according to claim 11, wherein the number of centrifugal partition chromatography extraction cells (14, 24) per rotor is between 30 and 100, where the total length of the column is between 2.5 m and 4.1 m.

13. A centrifugal partition chromatography apparatus; comprising one or more rotors according to claim 11.

14. A method for production of a centrifugal partition chromatography extraction cell (14, 24) for use in a centrifugal partition chromatography apparatus, wherein a helical piece shaped insert (11, 21) according to claim 1 is placed in the inside of the extraction cell or the helical piece is formed in it.

15. The method according to claim 14, wherein the helical piece shaped insert (11, 21) is placed inside the extraction cell or the helical piece shaped insert (11, 21) is created in it that has break-offs (12) formed on its side towards the cell wall of a size so that during the separation the entire amount of the mobile phase falls through the break-off (12).
